(19) United States
(12) Patent Application Publication
(10) Pub. No.: US 2014/0086544 A1
(43) Pub. Date: Mar. 27, 2014

(54) OPTICAL FIBER

(71) Applicants: Matthias Auth, Essen (DE); Jorg Kotzing, Jena (DE); Harald Hein, Jena (DE); Elke Poppitz, Jena (DE); Wolfgang Haemmerle, Jena (DE); Lothar Brehm, Jena (DE); Christian Genz, Jena (DE)

(72) Inventors: Matthias Auth, Essen (DE); Jorg Kotzing, Jena (DE); Harald Hein, Jena (DE); Elke Poppitz, Jena (DE); Wolfgang Haemmerle, Jena (DE); Lothar Brehm, Jena (DE); Christian Genz, Jena (DE)

(73) Assignee: j-plasma GmbH, Jena (DE)

(21) Appl. No.: 14/123,016

(22) PCT Filed: May 24, 2012
(86) PCT No.: PCT/EP2012/059743

§ 371 Date: Nov. 27, 2013

(30) Foreign Application Priority Data
May 27, 2011 (DE) 102011103860.8
Aug. 9, 2011 (DE) 102011109838.4

(51) Int. Cl. G02B 6/036

(52) U.S. Cl. CPC G02B 6/036
USPC 385/126

(57) ABSTRACT

An optical fiber has a core region, a cladding region and at least one spacer layer disposed between the core region and the cladding region. The core region is positively doped and has a positive refractive index with respect to the glass matrix of the optical fiber. The cladding region is negatively doped and has a refractive index of at most zero with respect to the glass matrix. The numerical aperture of the optical fiber is composed of variable proportions of the positively doped core region and the negatively doped cladding region and results from the refractive indices of both regions.

### BACKGROUND

Optical fibers typically include a transparent core surrounded by a transparent cladding material with a lower index of refraction than that of the core. The core is herein also referred to as the “core region” and the cladding is also referred to as the “cladding region” of the optical fiber.

In optics, the numerical aperture (NA) of an optical system, such as an optical fiber, is a dimensionless number that characterizes the range of angles over which the system can accept or emit light. The numerical aperture is based on the refractive indices of the core and cladding and increases with increasing difference of the refractive index of the core and the cladding. To produce optical fibers with large refractive index differences, typically both the core and the cladding are doped. The doping of the core as well as the cladding, however, is generally limited by chemical and process boundaries.

The different refractive indices of the core and the cladding regions are produced by using different dopants in the core and cladding. These dopants can increase or decrease the refractive index. Examples of optical fibers having a large difference in refractive indices in their cores and cladding, called high-NA fibers, are disclosed in Japanese Patent No. JP 57-32404. To achieve a low loss transmission, it is generally important to maintain the refractive index profile as precisely as possible within the optical fiber preform and the resulting optical fiber. There is, however, a problem due to production-related effects of temperature used in the preform production and temperature during operational use of the optical fiber. Heat encourages diffusion processes between the core and the cladding regions. The diffusion processes take place according to the concentration gradient of each dopant of the core and cladding. This results in a change in dopant concentration within the core and cladding interface. Further, the formation of undesirable volatile compounds that interfere with the interface may occur. In conventional manufacturing methods, this effect typically results in mechanical instabilities of the fibers which result in fiber breaks and higher fiber diameter variations. In addition, the optical parameters such as the refractive index profile are disturbed. Diffusions are increased when the dopant concentrations and the concentration gradient between the core and cladding are increased.

It is therefore desirable to have an optical fiber in which the disadvantages just described can be effectively reduced or eliminated. In addition, it is desirable to have a fiber with a very high mechanical strength.

Information relevant to attempts to address these problems can be found in German Patent No. DE 2426376 in which a hollow optical fiber is disclosed. The hollow optical fiber includes a thin inner layer serving as a photoconductive layer.

In German Patent No. DE 2930399, a fiber with a barrier layer which ensures high optical bandwidth is described. One significant disadvantage of this method is that B₂O₃ is used as a dopant, which introduces additional problems at the interface of the core and cladding and also does not form part of the core and/or cladding. Furthermore, the cladding also does not have the required refractive index relative to the glass matrix.

In German Patent No. DE 2530786, a process is described wherein the last layer applied to the inner wall of a tube is doped with a dopant less volatile than the dopant of the preceding layer. This method is not applicable to the present problem, as the problem solved in DE 2530786 is not the prevention of evaporation, but avoidance of the formation of volatile substances as a result of chemical reactions between the various glass constituents. Further, the disclosed method does not improve mechanical fiber strength.

In German Patent No. DE 2647419, an optical waveguide is disclosed consisting of an intermediate layer, a core region and a cladding region. The cladding region, however, is on the glass matrix level and therefore has no refractive index trench on it. Therefore, generally only very small numerical apertures can be realized with this invention. Similar disadvantages are found in German Patent No. DE2841909.

It remains desirable to have an optical fiber with a high refractive index with reduced core-cladding interface reactions where the optical fiber also has improved mechanical strength.

### SUMMARY

The present invention is directed to an optical fiber having a doped core and a doped cladding with one or more protective spacer layers and methods of its manufacture.

Embodiments of optical fibers and preforms for producing the optical fiber according to principles of the invention are described below. In one optical fiber embodiment, a core region has an increased core refractive index relative to a refractive index value of the glass matrix of the optical fiber. Further, the cladding region has a decreased cladding refractive index relative to the refractive index value of the glass matrix. The numerical aperture of the optical fiber is determined by the core region and the cladding region. Between the core region and the cladding region, a spacer layer is formed, the thickness of which is such that the numerical aperture of the optical fiber or the preform is determined by the refractive indices of the core region and the cladding region.

As described above, the core region has a core refractive index which is increased with respect to the refractive index value of the glass matrix. This increase is achieved by doping the core with at least one further substance. As stated above, the numerical aperture results from the refractive index difference between the core and the cladding of the optical fiber. To yield the necessary refractive index difference, at least a part of the core is formed to have the refractive index of the glass matrix. Further, the refractive index of the cladding is reduced to achieve the desired numerical aperture.

Therefore it is an object of the present invention to produce long fibers having a high numerical aperture, particularly with small variations in diameter and high mechanical strength.

In another embodiment, an optical fiber has a core region, a cladding region, and at least one spacer layer disposed between the core region and the cladding region. The at least one spacer layer has a wall thickness. The core region, cladding region and the at least one spacer layer form a glass matrix. The core region is positively doped and has a positive refractive index with respect to the glass matrix and the cladding region is negatively doped and has a refractive index of at most zero with respect to the glass matrix. The numerical aperture of the optical fiber is composed of variable proportions of the positively doped core region and the negatively doped cladding region and results from the refractive indices of both regions.

Further embodiments of the optical fiber or the perform are as follows. The fiber or preform for the production of the fiber contains a core region and a cladding region. The core region has an increased refractive index and the cladding region has a decreased refractive index with respect to the glass matrix. The numerical aperture of the fiber results from both the core and the cladding region. There is at least one spacer layer that operates as a protection or diffusion or barrier and/or buffer layer between the core region and the cladding. The spacer layer has a width, or “thickness”, where the resulting numerical aperture of the fiber is influenced by the varying parts of the updoped core and the downdoped cladding or by both parts.

The at least one spacer layer is built as a protection, diffusion, barrier and/or buffer layer between the core and the cladding. The spacer layer has a width that influences the numerical aperture of the fiber. The numerical aperture results further from varying parts of the updoped core and the downdoped cladding and is influenced by both parts. The spacer layer may be assigned either to the core or cladding region with respect to the numerical aperture. In some embodiments, the spacer layer is so thin, that it does not significantly contribute to the numerical aperture.

The spacer layer generally operates to prevent the aforementioned diffusion processes, or the diffusion processes are at least limited to the range of the spacer layer region. The spacer layer thus serves to maintain the refractive index profile and thus provide a value generated in the production of the numerical aperture.

The cladding of the optical fiber has in one embodiment at least one refractive index trench. In another embodiment, the optical fiber is formed as an optical fiber having a high numerical aperture in the form of a high-NA fiber. In an alternative embodiment, the optical fiber has a core region that includes a first dopant and a cladding region that includes a second dopant such that the optical fiber has a high numerical aperture.

In another alternative embodiment, the at least one spacer layer consists of several intermediate or transition glasses of different chemical composition.

Glasses with different compositions cannot always be combined, i. e., it is possible to have a poor connection between glass layers of different types. Chemical composition can be determined with the aid of phase diagrams. As it is possible that certain types of glass forming mixture gaps exist, therefore, certain glass types cannot be combined. Although a miscibility gap is an extreme value, problems are possible in a combination of miscible glasses, for example due to different thermal expansion coefficients. Transition or intermediate glass layers used in such cases act as a bonding agent for various types of glass.

It is therefore provided in one embodiment, a spacer layer that acts as a transition layer between the glass core region and cladding region of the fiber. In an alternative arrangement, the spacer layer is formed of regions of intermediate glasses of different chemical compositions.

In another arrangement, the spacer layer is a pure silica glass layer. In an alternative arrangement, the spacer layer includes at least one dopant of the core region and/or the cladding region. Typically, saturation with one or two dopants can be tolerated as long as the spacer layer prevents further diffusion of dopants and thereby forms a suitable intermediate glass. Accordingly, in another alternative arrangement, the at least one spacer layer is formed from a plurality of intermediate glasses of different chemical compositions. In another alternative embodiment, the numerical aperture (NA) of the fiber has a value of more than 0.20, which is defined generally as the high-NA area.

In another embodiment, the thickness of the spacer layer has a value from 0.05 to 3.5 μm with respect to the standard fiber glass diameter of 125 μm. This value may refer to other fiber cross sections or preform designs be converted accordingly.

The spacer layer also provides another advantage. The resulting numerical aperture of the fiber depends on the wall thickness of the spacer layer in addition to the absolute refractive index difference between core and cladding. Very thin spacer layer wall thickness have almost no influence on the resulting numerical aperture ideally composed additively from the refractive index differences of the core and of the cladding region.

By increasing wall thickness, however, the numerical aperture is determined only by increasing the refractive index difference of the core to the spacer layer. The amount or the influence of the cladding region with lower refractive index to the numerical aperture decreases gradually.

In one embodiment, therefore, the wall thickness of the spacer layer in the preform has a predetermined thickness such that the numerical aperture is influenced by the cladding region and can be tuned by adjusting the wall thickness. The wall thickness of the spacer layer can be controlled during the manufacturing process. These layers are usually deposited by means of outside vapor deposition processes, e.g., plasma outside vapor deposition (POVD) or flame burners.

The spacer layer also acts as a buffer layer to mitigate procedurally related refractive index interference to a certain extent.

One skilled in the art of fiber optics will understand that some layers may deviate from circular geometries, e.g. polygonal, preferably octagonal or hexagonal. Accordingly, in some embodiments, at least one of the spacer layers, the core region and/or the cladding region can be built at least partially deviating from the circular symmetry in cross section, preferably a hexagonal or octagonal cross section.

In the core region, the cladding region or a plurality of the at least one spacer layer refractive index-altered structures stages may be provided, which differ in their form. The differences in form include differences in chemical composition and/or wall thickness. In one embodiment, the at least one layer is produced with laser-active ions, such that an active fiber is produced. In this case, embodiments with multiple trenches are generally preferable. In some embodiments, the laser-active ions are selected from the group of elements consisting of Ho, Yb, Er, Sm, Ti, Nd, Tm, Cr, Co, and Pr.

In another embodiment is at least in sections provided with recesses individual layers. This results in a particularly good mode mixing.

Further, in some embodiments, the optical fibers have a stepped profile depending on the composition and/or a gradient in the core and/or cladding region. In some arrangements, the step structures are separated by spacer layers, wherein the spacer layers differ from each other in form. The differences in form include differences in the chemical composition and/or wall thickness of the spacer layers located between the step structures.

Four options are possible:

| Variant | Core | Cladding |
|---|---|---|
| 1 | Step index | Step index |
| 2 | Step index | Gradient index |
| 3 | Gradient index | Step index |
| 4 | Gradient index | Gradient index |

The optical fiber and preform will be explained in more detail with reference to embodiments. The following figures serve to illustrate the scope of the invention. The same reference numerals represent the same or equivalent parts. The following description applies to both multimode and single mode fibers. Generally, the optical fiber is configured such that its operation and/or measuring of their numerical aperture can be done at full excitation of all modes capable of propagation or with a reduced mode excitation. In a method for manufacturing an optical fiber according to an embodiment of the invention, the optical fiber has a core region, a cladding region, and at least one spacer layer disposed between the core region and the cladding region, the at least one spacer layer having a wall thickness, wherein the core region, cladding region and at least one spacer layer form a glass matrix, wherein the core region is positively doped and has a positive refractive index with respect to the glass matrix and the cladding region is negatively doped and has a refractive index of at most zero with respect to the glass matrix, and wherein the numerical aperture of the optical fiber is composed of variable proportions of the positively doped core region and the negatively doped cladding region and results from the refractive indices of both regions. The method includes the step of applying the spacer layer with an outside deposition process. The outside deposition process is, for example, outside vapor deposition, chemical vapor deposition, plasma outside vapor deposition, flame hydrolysis, or a smoker. In some embodiments, the spacer layer is applied on a rotationally symmetrical structure such as a rod or a tube. The rotationally symmetrical structure is a tube. The tube has an inner surface, and the method further includes applying layers on the inner side with an inside deposition process. The present invention together with the above and other advantages may best be understood from the following detailed description of the embodiments of the invention illustrated in the drawings, wherein:

### DRAWINGS

FIG. 1 shows an exemplary refractive index profile with a step-index core, a step-index cladding with lower refractive index adjacent to the core and a thin spacer layer between core and cladding according to principles of the invention;

FIG. 2 is an exemplary refractive index profile with a graded-index core, an adjacent cladding region with lower graded-refractive index and a thin spacer layer disposed therebetween according to principles of the invention;

FIG. 3 shows a tube with an inner spacer layer, a downdoped portion, an undoped or doped intermediate layer, another downdoped region and an outer protective layer according to an embodiment of the invention; and

FIG. 4 shows an embodiment including an inner layer, a downdoped region and an outer protection layer.

### DESCRIPTION

Optical fibers having a doped core and a doped cladding with one or more spacer layers disposed between the core and cladding are disclosed along with methods of their manufacture. The spacer layer acts as a protective barrier.

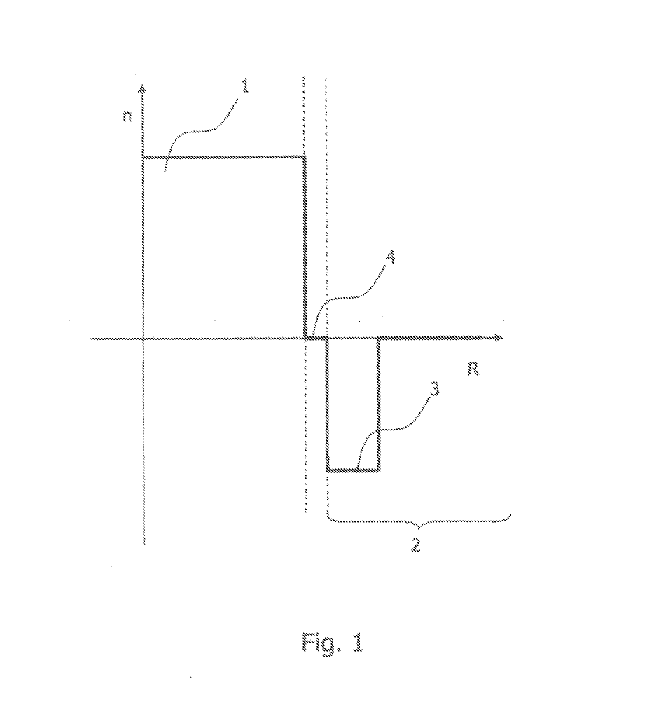

FIG. 1 shows a first example of a refractive index profile, the refractive index shape depending on optical fiber radius R. The refractive index shown is normalized to the value of a refractive index serving as a base material for the glass fiber.

Positive values indicate an increased refractive index compared to the refractive index of fused silica glass; negative refractive index values indicate a reduced refractive index compared to the refractive index of fused silica glass.

It is possible to distinguish two major areas in the optical fiber. Within the core region 1 there is a positive refractive index. Within a fiber cladding region 2, the refractive index is, in this example, either at the level of the glass matrix, and thus is zero or less and therefore negative. The cladding region 3 may include at least one refractive index trench. Between the core region 1 and the fiber cladding 2, in particular, the trench, the spacer layer 4 is formed. Compared to the core region 1 and to the fiber cladding 2 and especially the trench 3, the spacer layer 4 has only a small thickness, or “width”.

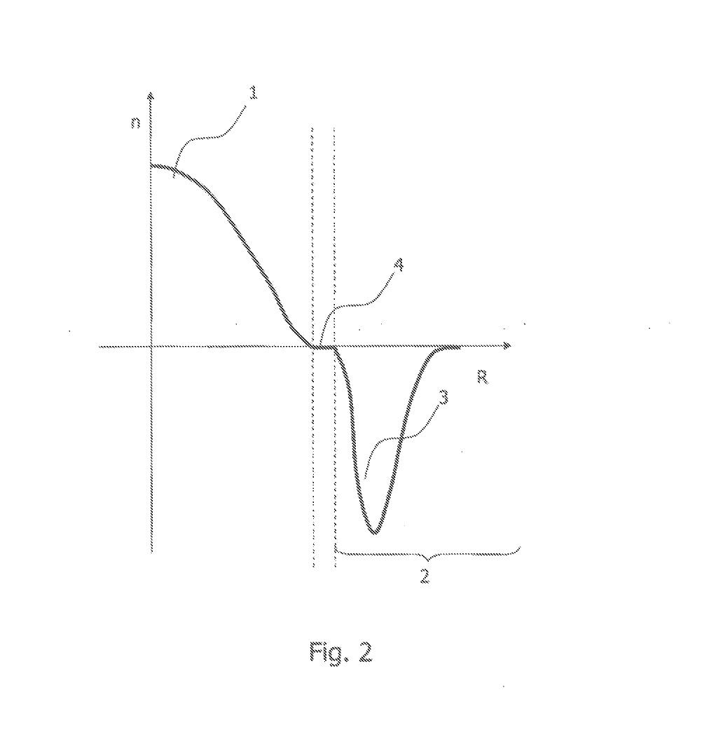

The step-index design of the refractive index profile shown in FIG. 1 can also be formed differently, that is, more gradual. FIG. 2 shows an example.

In FIG. 2, the refractive index profile of the core region 1 decreases with increasing radius in a gradual manner. The refractive index profile of the trench 3 is sloped on both sides. It can be understood by one skilled in the art that either the core or the gap may readily be formed stepwise and that one of the flanks of the trench can be carried out as a step. Also in this example, the spacer layer 4 between the core region and the trench is formed. It is located in terms of its index of refraction and also at the level of the refractive index of the glass matrix.

The spacer layer in these embodiments is preferably made of undoped quartz glass, but depending on the application, at least one dopant can be included. In this case, the doped spacer layer may be assigned either to the core or the cladding. The trench, for example, is fluorine-doped and has a refractive index difference Δn of −0.004 to −0.026, preferably −0.009.

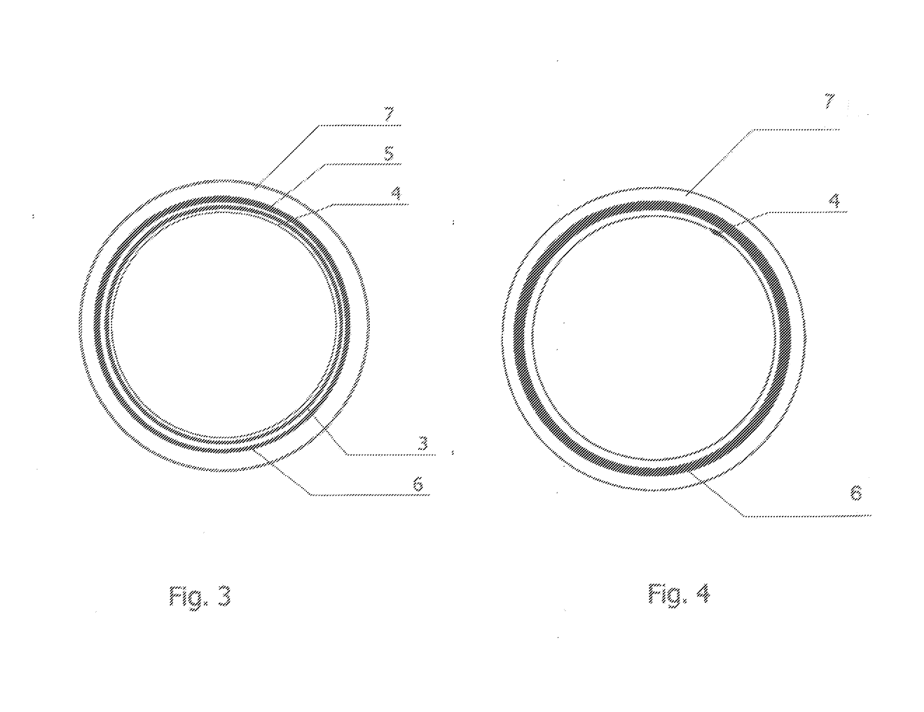

The optical fiber can be produced in the preform by deposition processes, preferably with plasma outside vapor deposition (POVD), or modified chemical vapor deposition (MCVD), or a so-called Smoker. The core region is doped with germanium, for example, or a comparable refractive index increasing dopant. In addition, multiple trenches may be applied. Different semi-finished products for single- or multimode fibers are shown in FIGS. 3 and 4. FIG. 3 shows a tube with an inner spacer layer 4, a downdoped region 3, an undoped or doped intermediate layer 5, another downdoped portion 6 and an outer protective layer 7. FIG. 4 shows an embodiment having an inner spacer layer 4, a downdoped region 6 and an outer protective layer 7. The outer diameter of the tubular preforms or semi finished products are each 30 to 40 mm and the inner diameter 25 to 35 mm. The deposition of the inner spacer layer 4 is made of quartz glass with a thickness between 0.2-1.2 mm, preferably 0.7 mm. The formation of a first doped trench 3 with a wall thickness of 0.2-1.3 mm, preferably 0.7 mm and a refractive index change of Δn in amount from 0.001 to 0.007, preferably 0.0025, is accomplished using deposition processes, for example, POVD, MCVD method or the so-called Smoker. Another intermediate layer of quartz glass having a wall thickness between 0.01 mm and 2.5 mm, preferably 0.7 mm, is applied by means of the aforementioned methods. The intermediate layer may be either non-doped quartz glass or doped silica glass having a refractive index difference Δn2 preferably: Δn2=−Δn+/−0.001

Following the intermediate layer 5 a fluorine-doped trench 6 with a wall thickness of 0.3-2.5 mm, preferably 1.0 mm, and a refractive index reduction of Δn from −0.006 to −0.026, preferably −0.018 is formed.

The fluorine-doped trench 6 is alternatively produced with a wall thickness of 0.4-2.5 mm, preferably 1.5 mm and a refractive index reduction of Δn from −0.004 to −0.026, preferably −0.009. The fluorine-doped trench 6 is formed by means of deposition processes, for example POVD, MCVD method, or the so-called Smoker. The preform is provided with an outer protective layer 7, which preferably consists of undoped quartz glass with a wall thickness between 0.1 and 3 mm preferably 0.5 mm. Subsequently, by means of inside deposition processes such as MCVD or Plasma Inside vapor deposition (PIVD), the desired refractive index profile of the core region is produced.

The manufacturing process are described in detail in the following four examples: Example 1: In the first step, an auxiliary material for the tube production is used, preferably a graphite or SiC-rod, however, any other heat-resistant and temperature resistant material can be used. In this example, a graphite rod with a 43 mm outer diameter is used. In the following step, the spacer layer with a wall thickness of 1 to 2 mm, preferably 1.5 mm is formed on the graphite rod. To form a spacer layer, a substrate tube can be collapsed onto the graphite rod or the spacer layer may be directly deposited onto the graphite rod. This inner spacer layer is preferably made of undoped quartz glass, but depending on the application, may contain at least one dopant. Subsequently, a fluorine-doped trench is formed. The fluorine-doped trench has a wall thickness, for example, of 1.5-2.5 mm, preferably 2 mm and a refractive index reduction of Δn is from −0.002 to −0.026, preferably −0.009. The fluorine-doped trench is formed by means of deposition processes, for example, an OVD or CVD method, POVD method, flame pyrolysis or the so-called Smoker. This step is followed by the deposition of an outer protective layer of 0.2-3 mm, preferably 1 mm, preferably of undoped quartz glass, either by collapsing a glass tube having a desired composition, or by direct deposition with the aforementioned methods. Adding an outer protective layer has the advantage that the outer surface of the tube is protected and the tube has an increased mechanical stability. After removal of the auxiliary material—in the present example of the graphite rod—there is a processing and/or purification and/or thermal treatment of the inner surface. This procedure is followed by a stretching step, so that the outer diameter of the new tube is 24 to 36 mm preferably 32 mm. In this tube, the light-guiding layers using the CVD or POVD are deposited, where the refractive index increases continuously at a graduated core area of a certain number of layers. Finally, the thus prepared tube is collapsed to a solid rod, or a capillary. The resulting product is encompassed by the treatment of the outer surface with at least one tube of a desired thickness and refractive index, or as part of a direct deposition, with further layers of desired thickness and refractive index. Thereby a correct core-to-clad-ratio of the subsequent optical fiber has been formed. Example 2: In the first step, the provision of an auxiliary material for the tube production is carried out. The auxiliary material is preferably of graphite or SiC-rod, however, any other heat-resistant and temperature-resistant material may be used. In the example, a graphite rod with 43 mm outer diameter is used. In the following step, a glass soot layer with the desired refractive index is deposited on the graphite rod. Thereafter, the deposition of a portion of the spacer layer, preferably composed of quartz glass with a thickness between 0.2-1.2 mm, preferably 0.7 mm is carried out. Subsequently, the formation of a first trench with a wall thickness of 0.2-1.3 mm, preferably 0.7 mm and a refractive index change of Δn in the range from 0.001 to 0.005, preferably 0.0025, is carried out. The trench is formed using deposition processes, for example, OVD, CVD, plasma inside vapor deposition (PIVD), flame pyrolysis, or the so-called Smoker. Then, another intermediate layer of quartz glass is formed. The additional intermediate layer has a wall thickness, for example, between 0.01 mm and 2.5 mm, preferably 0.7 mm. This intermediate layer is formed by means of the aforementioned methods. The intermediate layer is either non-doped quartz glass or doped silica glass, wherein the refractive index difference Δn2 is preferably:

Δn2=−Δn+/−0.001

Following the formation of this intermediate layer, a fluorine-doped trench with a wall thickness of 0.3-2.5 mm preferably 1.0 mm and a refractive index reduction of Δn from −0.002 to 0.026, preferably −0.009 is deposited. An outer protective layer of non-doped quartz glass is then applied. After removal of the auxiliary material—in the present example of the graphite rod—there is a processing and/or purification and/or thermal treatment of the inner surface. A stretching step is then carried out, such that the outside diameter of the new tube is 24 to 36 mm preferably 32 mm. In this tube, the desired wall thickness of the spacer layer is first deposited using the CVD or PIVD. Next, the deposition of the light-guiding layers is carried out, wherein the refractive index is increased continuously after a certain number of layers for a graded-index profile. The remaining steps are similar to those of the Example 1. Example 3: In a first step, the provision of an auxiliary material for the tube production is carried out. The auxiliary material is preferably of graphite or SiC-rod, however, any other heat-resistant and temperature-resistant material can be used. In the example, a graphite rod with 43 mm outer diameter is used. In the following step, the graphite rod is covered with a glass soot layer of a desired refractive index. This layer is at least partly fused by subsequent deposition processes into a glass layer. Subsequently, a fluorine-doped trench is formed, the trench having a wall thickness of 0.4-3 mm, preferably 1.5 mm and a refractive index reduction of Δn from −0.002 to −0.026, preferably −0.006 to −0.015, and more preferably at −0.009. The fluorine-doped trench is formed using deposition processes, for example, OVD, MCVD, POVD, flame pyrolysis, or the so-called Smoker. This tube is provided with an outer protective layer, which preferably consists of undoped quartz glass, and has a wall thickness between 0.1 and 3 mm preferably 0.5 mm. After removal of the auxiliary material—in the present example of the graphite rod—there is a processing and/or purification and/or thermal treatment of the inner surface. One or more stretching steps may be added to the process. Subsequently, with the aid of inside deposition processes such as MCVD or plasma inside vapor deposition (PIVD) the spacer layer is formed with a desired thickness. Subsequently, the light-guiding layer is formed with a desired refractive index sequence. After completion of the inside deposition, a heat treatment and/or stretching process may be performed. The resulting product is encompassed by the treatment of the outer surface with at least one tube of desired thickness and refractive index, or as part of a direct deposition with further layers of desired thickness and refractive index. Thereby the correct core-to-clad-ration of the subsequent optical fiber is produced.

Example 4: In a substrate tube, the light-guiding layers are deposited using inside deposition processes such as MCVD, PIVD (Plasma Inside vapor deposition) or CVD. Subsequently, the thus prepared tube is collapsed to a solid rod, or a capillary. The substrate tube is completely or partly removed, and the outer surface treated. Optionally, stretching or compression processes can be carried out. As a final step, the outer deposition of silica glass layers takes place with the desired refractive index and thickness of the glass, by means of deposition processes, preferably wherein the OVD or CVD method, in particular POVD method, flame pyrolysis or the so-called Smoker are used.

By means of the methods listed above, a layer sequence in the form of individual trenches, and/or intermediate layers can be realized. One of skill in the art will understand that the embodiments set forth herein are merely exemplary and that the sequence of the individual steps and deposition parameters such as refractive index, thickness, diameter, layer number and sequence may be adapted in accordance with the problem to be solved.

### LIST OF REFERENCE NUMERALS

1: core area
2: fiber cladding
3: negative cladding area, trench
4 spacer layer
5: intermediate layer
6: downdoped area
7: protective outer layer

It is to be understood that the above-identified embodiments are simply illustrative of the principles of the invention. Various and other modifications and changes may be made by those skilled in the art which will embody the principles of the invention and fall within the spirit and scope thereof.

We claim:

1. An optical fiber, comprising:
a core region;
a cladding region; and
at least one spacer layer disposed between the core region and the cladding region, the at least one spacer layer having a wall thickness,
wherein the core region, cladding region and at least one spacer layer form a glass matrix,
wherein the core region is positively doped and has a positive refractive index with respect to the glass matrix and the cladding region is negatively doped and has a refractive index of at most zero with respect to the glass matrix, and
wherein the numerical aperture of the optical fiber is composed of variable proportions of the positively doped core region and the negatively doped cladding region and results from the refractive indices of both regions.

2. The optical fiber of claim 1 wherein the cladding region further comprises at least one trench.

3. The optical fiber of claim 1 wherein the core region includes a first dopant and wherein the cladding region includes a second dopant such that the optical fiber has a high numerical aperture.

4. The optical fiber of claim 1 wherein the spacer layer includes at least one dopant of the core region.

5. The optical fiber of claim 1 wherein the spacer layer includes at least one dopant of the cladding region.

6. The optical fiber of claim 1 wherein the spacer layer includes at least one dopant of each of the core region and the cladding region.

7. The optical fiber of claim 1 wherein the optical fiber has a numerical aperture value greater than 0.20.

8. The optical fiber of claim 1 wherein the wall thickness of the spacer layer has a value in the range of 0.05 to 3 μm.

9. The optical fiber of claim 1, wherein the optical fiber is formed from a perform, wherein the wall thickness of the spacer layer results from a predetermined thickness within the preform, thereby resulting in a predetermined contribution of the cladding region to the numerical aperture, whereby the numerical aperture is adjustable by adjusting the predetermined thickness within the perform.

10. The optical fiber of claim 1, wherein the optical fiber deviates at least partially from circular symmetry in cross section.

11. The optical fiber of claim 1, wherein at least one spacer layer includes laser-active ions.

12. The optical fiber of claim 11 wherein the laser-active ions are selected from the group of elements consisting of Ho, Yb, Er, Sm, Ti, Nd, Tm, Cr, Co, and Pr.

13. The optical fiber of claim 1, wherein the at least one spacer layer is formed from a plurality of intermediate glasses of different chemical compositions.

14. The optical fiber of claim 1 wherein at least one of the core region, the cladding region or the at least one spacer layer includes a plurality of refractive index-altered step structures wherein the plurality of refractive index-altered step structures differ in form.

15. The optical fiber of claim 14, wherein the step structures are separated by separation spacer layers, wherein the separation spacer layers differ from each other in form.

16. The optical fiber of claim 1 wherein operation of the optical fiber and the measurement of the numerical aperture can be performed during a full excitation of all modes capable of propagation and also in a reduced mode excitation.

17. A method for manufacturing an optical fiber, the optical fiber having a core region, a cladding region, and at least one spacer layer disposed between the core region and the cladding region, the at least one spacer layer having a wall thickness, wherein the core region, cladding region and at least one spacer layer form a glass matrix, wherein the core region is positively doped and has a positive refractive index with respect to the glass matrix and the cladding region is negatively doped and has a refractive index of at most zero with respect to the glass matrix, and wherein the numerical aperture of the optical fiber is composed of variable proportions of the positively doped core region and the negatively doped cladding region and results from the refractive indices of both regions, the method comprising:
applying the spacer layer with an outside deposition process, wherein the outside deposition process is selected from the group consisting of outside vapor deposition, chemical vapor deposition, plasma outside vapor deposition, flame hydrolysis, and a smoker, wherein the spacer layer is applied on a rotationally symmetrical structure.

18. The method of claim 17 where the rotationally symmetrical structure is a tube, the tube having an inner side, the method further comprising applying layers on the inner side with an inside deposition process.
